(19) United States
(12) Patent Application Publication
(10) Pub. No.: US 2005/0092776 A1
(43) Pub. Date: May 5, 2005

(54) Caulking and grease device

(76) Inventors: Willie Joe Brock, Jonesboro, GA (US); Karen Denice Brock, Jonesboro, GA (US)

Correspondence Address: Mr. Willie Joe Brock, P. O. Box 90669, East Point, GA, 30364, US

(21) Appl. No.: 10/452,608

(22) Filed: Oct. 24, 2003

(51) Int. Cl. G01F 11/06

(52) U.S. Cl. 222/325

(57) ABSTRACT

The invention disclosed here-in provides a detachable mounting removable cradle and a rear housing device, with a shaft extending horizontally through the rear housing into the removable cradles, to extract or remove compound substances such as caulking or grease. The purpose for the present invention, the rear housing and front cradle driven power system, is twofold. Its uses would enhance the work load in building, and in the small lubrication industry, as well as offer a healthier and safer working environment. Therefore this improved detachable mounting caulking and grease system is for the purpose of giving the user the option of a hand held electric power driven system, a means for less movement of the hands, fingers, and arms, that may lead to the cause of physical conditions and injuries such as caper-tunnel and arthritis in the wrist joints. This arrangement is an improvement over other methods, such as hand held manually operated systems of original hand held devices. The present invention is designed for safety, but to accomplish a job with a minimum expenditure of time and effort. These separate mounting cradles and the rear housing that makes the connection to the portable or electric drill, are all designed steel bracket as per drawing, mounted on top of a hand held drill housing to hold or bear the weight with a supporting launching pad, to rest on top of the drill housing, with a reinforced locking system as per drawing, attached to the rear of the drill housing.

### BACKGROUND OF THE INVENTION

This invention here-in provides a mounting removable housing with detachable removable cradles. The removable housing provides a secure system attached or mounted on top of a hand held battery or electric operated variable speed drill. The rear housing and removable cradles of the invention are provided with an internal shaft that extends through the rear housing into the removable cradles, with an engagable front head or disk device, attached to the front end of the shaft. Thus permitting a means for the removal or the start of the process of removing ingredients of compound substances such as caulking, to fill or close seams, joints or to make water tight or air tight in existing openings.

The present invention as designed is especially adaptable to be used as a grease gun, by permitting and installing a similar tubular cartridge into the cradle designed for greasing only, on the same housing mechanism of the present invention, FIG. 2. By disconnecting at the point of disconnect at Claim 6 and 7 for removal of cradles from rear housing rods of FIG. 2 as per diagrams or drawing. Claim 6 and 7 are receivers of Claim 9 front cradles of FIG. 1. All substances such as caulking compounds or grease, can be used and discharged by the present invention, by changing the different size cradles, designed for its prescribable or designated function, labeled or marked grease or caulking only when used for different purposed such as commercial, industrial or residential building uses.

The present invention can be used as a grease gun in garages, machine shops, and factories or for the greasing of vehicles or larger and smaller automotive powered machinery. Including boats and greasing of various vehicles or any type of machinery can be applied by variable speeds also for caulking purposes.

This feature or arrangement is an improvement over hand held or other methods, the results is two fold, its housing and cradles are removable to allow the user to use its battery operated or electric drill independently from the designed invention when used would no longer require hand methods to release its substances.

The power actions, having speed control, are influenced by a trigger hand operated variable speeds battery or electric power, the objective of the power operating means of the present invention is to provide an easier means for releasing caulking and grease substances, through a system that can reduce injuries or disabilities such as carpal tunnel syndrome in the hands, and arthritis in the fingers and arms that may occur from use over a long period of time, by providing a new and improved system, for extensive commercial, industrial and residential work will reduce long term injuries of the limbs.

### SUMMARY OF THE INVENTION

The foregoing system and its advantages of the present invention are accomplished in this new and improved detachable dispensing system, when used with a battery operated or electric drill but when separated the drill is capable of operating independently. When operationally connected they become one independent system. They minimize or reduce the possibility of personal injuries; Claim 4 is designed especially as a protective shield that includes a gear operated by a controlled member of the drill. A triggered levered handle arranged to rotate the said controlled Claim 5, shaft, a variable speeds means. Through a control channel for engagement with a cradle type retainer, Claim 9, mounted on a housing platform of the present invention.

### BRIEF DESCRIPTION OF THE DRAWINGS

FIG. 1 is a rear housing mechanism having different connecting parts to function together as a whole; they are removable, remounting front cradles, as seen in FIGS. 11 and 12 and in FIGS. 18 and 19, having a rear cradle connecting section, Claim 9 and 10 are between two metal receivers, and an open device, Claim 9, to receive two steel rods, Claim 7, to be mounted on to the rear mechanism launching pad. The connecting sections are located at the rear end of FIG. 9 cradle, and the rear end opening, FIG. 10. Also the front end of the rear mechanism FIG. 1 rear housing that contains a front and rear grommet, Claim 11 and 13, opening a plastic, rubber washer or ring, inserted in the hole or opening to prevent grounding, vibration, and stability on top of the drill housing. The rear mechanism also contains a front housing protective loop metal device, Claim 14 and 23, developed and designed for protection of body parts to stop the effects of shifting or movement of the rear housing arrangement attach to the top of the portable drill. The mechanism contains an extended metal designed arm, so as to reach into a design lock down mechanism welded on top of drill housing for lock down purpose only, a cushion like protection covering, or as a saddle attached and welded onto the rear end of the rear mechanism a mounting pad, that permits the removal or the mounting of the complete secure attachable system on top of a hand held battery or any electric operated drill, with an attached welded lock down system attached to the rear of the pad, or rear housing of the portable drill.

FIG. 2 is a sectional side view of the caulking cradle and the actual steel side ribs with its front open compound receiver disk and the rear cradle mounting and removal end device.

FIG. 3 is a portable charger.

FIG. 4 is a U.S. patent drill by others to be respectively enhanced, illustrating a view of the present invention by showing the mounting relationship of a housing embodied with another system, is designed suitable to enhance another function other than what it was designed for.

FIG. 5 is the horizontal shaft or an axis activator device for a means of engagement or connection to something, for removal of grease or compound from cartridge.

FIG. 6 caulking compound holder, the cartridge are the same size for commercial and industrial uses. For residential uses the cartridges are smaller in size.

FIG. 7 is a portable drill battery.

FIG. 8 is a gear, used with other devices or hand held drill to move or impel horizontal shaft to dispense compound or grease.

FIG. 9 is a lock down pad system with a control, FIG. 15, arm, a device to provide a locking down mounting position of the housing a view, the embodiment of the invention shows the mounting relationship on the rear section of the drill housing.

FIG. 10 is the cradle rear housing opening to pass shaft horizontally through and to remove and install cradle on to housing mechanism of the launching pad.

FIG. 11 of this present invention is a cradle for the purpose of larger cartridge for commercial uses only.

FIG. 12 of this present invention is a cradle for the purpose of small cartridge for residential use only.

FIG. 13 is the front end of the cradle opening, with front openings for the cartridge to be place to dispense compound.

FIG. 14 is the rear housing lacking system control arm to provide a pull down lacking device.

FIG. 15 is a lacking catch with a device to catch and hold lacking systems in place.

FIG. 16 is a grommet, a rubber or plastic ring or washer, inserted in a special made hole to receive gasket to prevent grinding away or keep in position shaft or any other parts.

FIG. 17 is a rubber hose design to carry grease to a special fitting with a female metal attachment.

FIG. 18 is a special made greasing cradle for grease cartridge only, with front housing threaded to receive front end of cradle cap, or threaded round intake opening for residential use only.

FIG. 19 is the same design grease cradle only large for commercial use only.

FIG. 20 is a grease cartridge design for above cradles.

FIG. 21 is a holder to lock in place the grommet.

### DESCRIPTION OF THE PREFERRED EMBODIMENT

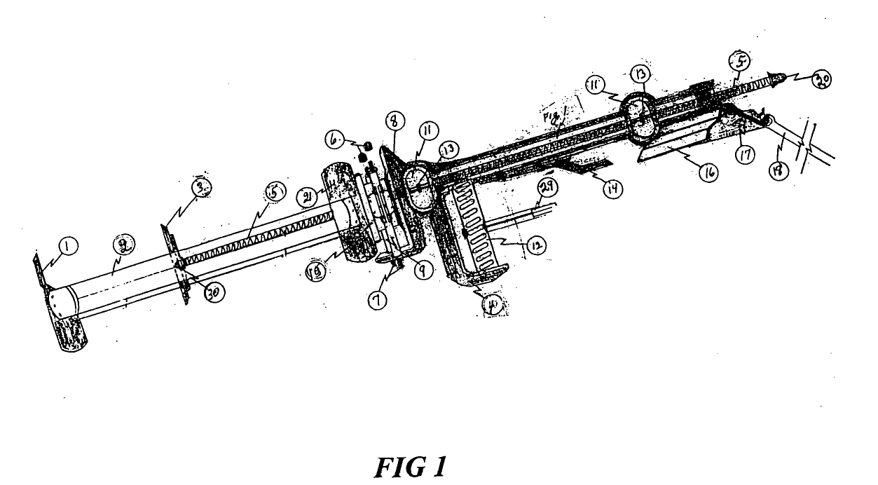

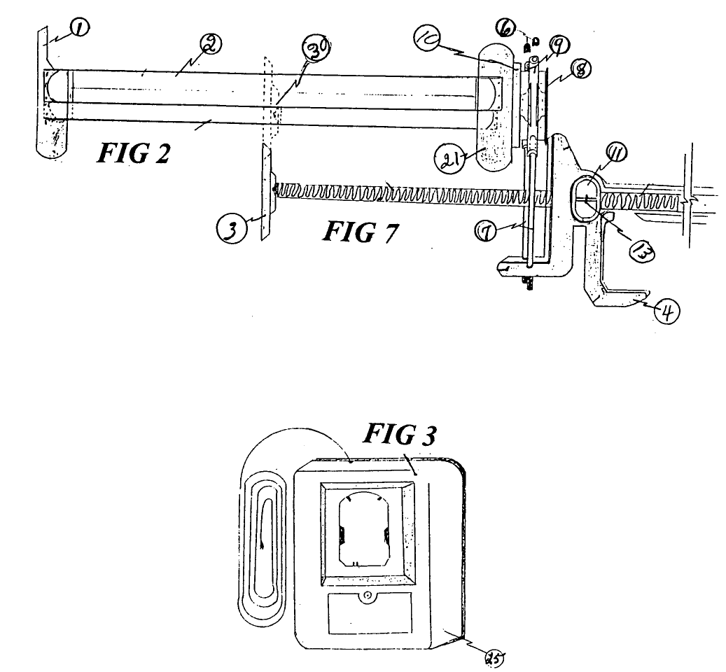

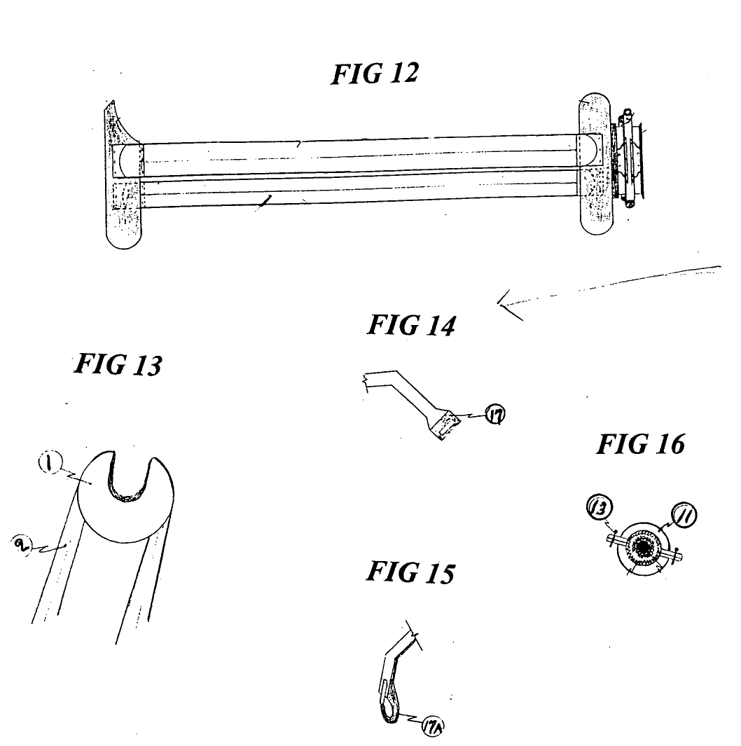

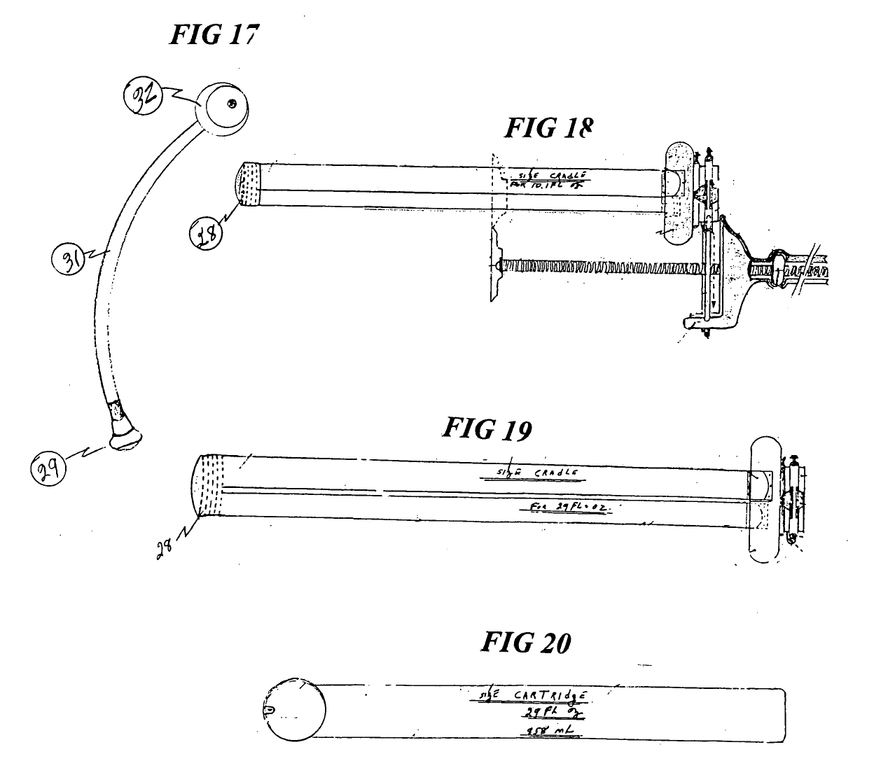

With reference to FIG. 2 of the present invention, the drawing of FIG. 11, FIG. 12, FIG. 18 and FIG. 19, mounting description, Claim 7 and Claim 9, shows a schematic view and the order in which the mounting and releasing arrangement of the cradles, are lifted from the rear housing mechanism of FIG. 1.

This connecting and removal of FIG. 2, the multipurpose caulking cradles, FIGS. 11 and 12, and FIGS. 18 and 19 grease cradles illustrates a vertical lifting or a descending position from the mounting pad of FIG. 1, having lock nuts, Claim 6, and washers on top of two, Claim 7, steels rods. It is this embodiment principle that becomes the portable battery operated electric multipurpose caulking and grease gun for cradle disconnect. The Claim 21 of FIG. 2, mounting metal engagement plate, is a stationary plate made to join end to end, of the cradle, FIG. 10, and rear housing section, absorbing, tension and to stabilize the junction where the disengaging members part and meet and separates.

The cradles Claim 9 receivers and guide tubes are receivers of Claim 7 steel mounting housing rods, Claim 7 retainer slides through the opening housing of Claim 9, through a circular hole with a covering opening to move up and down over Claim 7 steel rod resting on the mounting plate of FIG. 1 rear housing. Claim 10 is a middle plate or flange attach to the cradle 2 rib cage for balance control becoming a horizontal stabilizer to carry the weight of FIG. 2, FIG. 6 and FIG. 20, cartridge for caulking and greasing.

FIG. 10 rear plate of the cradle's removal section, depict a schematic view of Claim 22 opening in the rear end of the cradle housing of FIG. 10, with the Claim 5 shaft extending through the rear housing and into the removal cradle as per FIGS. 11, 12, 18, and 19 drawings. Claim 22 of FIG. 10 opening in the rear of each cradle provides a lifting vertical clearance for its means in the removal of all cradles, also providing the proper clearance for the horizontal movement of FIG. 5 shaft as seen in the cradle removal drawing of FIG. 10 and Claim 7.

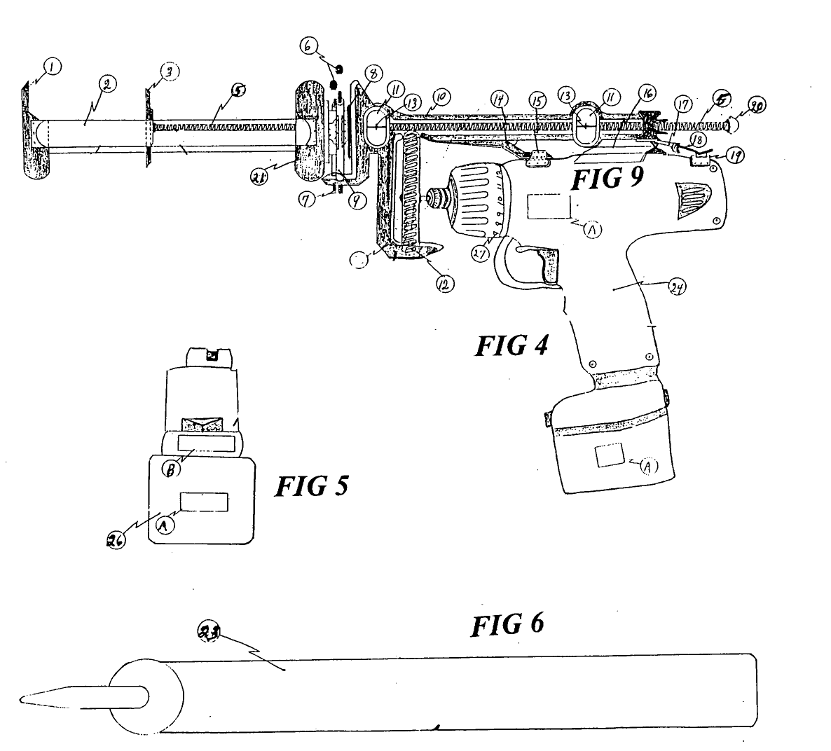

The cradles outer two ribs, Claim 2, frame supports and are attached to Claim 13 front end section of FIG. 2 cradle, with an accessible opening in the front disk suitable in design to receive the extended tubular cartridge of FIG. 6 front end guide for the dispensing of various caulking substances. As per drawing Claim 14, 15 and FIG. 14, the rear housing of FIG. 1 of the present invention is mounted on FIG. 4 portable or electric drill. FIG. 14 is a locking device and is seen in Claim 18 and 17 locking system, a control connecting arm attach to the present invention FIG. 1 rear housing. Claim 14 is a steel connecting especially designed extending plate which is securely welded to the bottom portion of the rear housing mechanism. This, Claim 14, extended plate support Claim 15 as rear housing mounting bracket on top of Claim 24 drill FIG. 4.

When the housing shaft, FIG. 5, is fully extended in the forward position Claim 20 end cap or nut becomes a stop, bringing the shaft to an arresting position. FIG. 5, front end of the shaft 30, is an oval disk or a plate that provides the means suitable for extracting any compound substance from the cartridge. This function gives a wide range of advantages with this removable caulking system in the present invention, the overall means comes through a portable battery driven shaft.

The greater benefit come through this hand held battery operated driven greasing system. They are component parts, incorporated in this embodiment of this present invention. This advantage is depicted in the drawing here-in FIG. 18 and FIG. 19 cradles, the same type in being removal cradles as seen in the caulking cradles in the present invention FIG. 1 housing attached to the rear housing. The cartridge, FIG. 11, is a smaller tube caulking embodiment residential, FIG. 12 is the same, only a bigger commercial type cartridge with a thread able, for removal of the front end special designed Claims 32 cap design, with a small round intake opening that forces the grease into a, Claims 31, rubber hose, a tube with a female grease end, Claim 29, fitting an adaptable end. A further view for the embodiment is a view of a retainer, FIG. 20, grease cartridge.

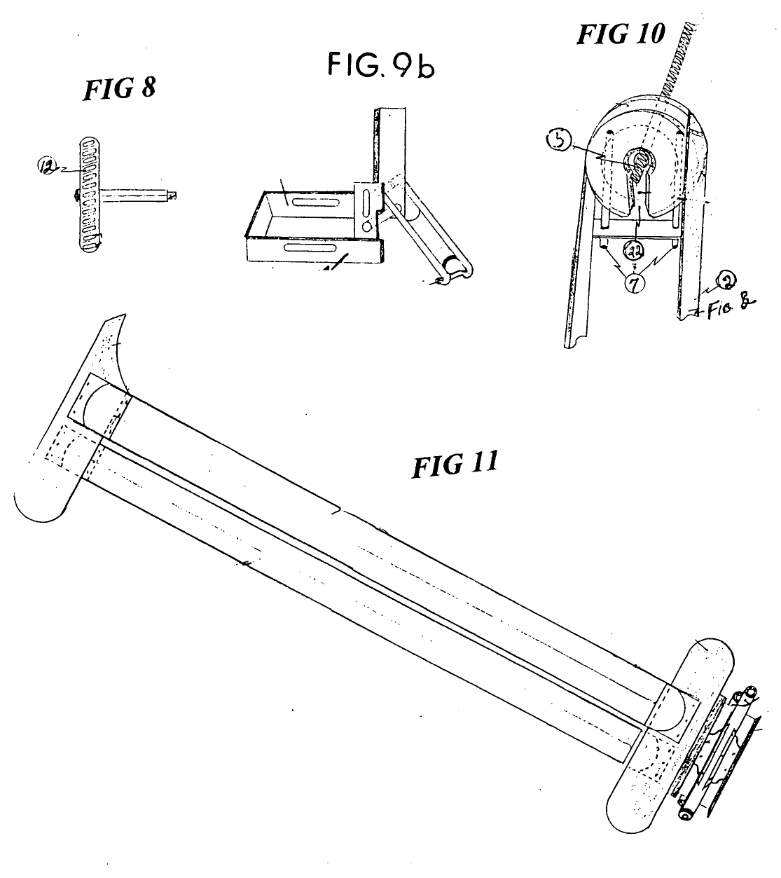

1. A portable housing assembly with separate independent removable front cradle, FIG. 2, designed to operate as a caulking and grease gun.
The alternative embodiments of the caulking and grease mechanism are four detachable cradles, having a detachable mechanism and rear housing. They are integrally design, when gained together as a whole, to function individually or separately as one complete housing assembly when joining the embodiment or cradles to the rear housing. FIG. 1, the mechanism is then complete. Each cradle becomes one operating arrangement to exert force in the compound holder or cartridge as an independent part. The shaft, claim 5, extends horizontally through the rear housing and into the removable cradles, to extract or remove compound substances such as caulking or grease from a tube type cartridge. The cartridges are selectable. A choice may be made of which cradles can be alternated, a means of selecting different cradle sizes becoming a valuable resource with the capability of producing a profitable end.
Claim 6 and 7 becomes the bridge for connecting members of the present invention, see the attached drawings. Claim 9 relies on FIG. 10 and claim 7. The gear, FIG. 8, is the control steering part of claim 12 having cut teeth to mesh with each other, in gear and out of gear, to perform one function by serving one purpose as a complex machine, to transmit force, forward or reverse, changing the direction or to turn in an opposite direction, FIG. 8, by a forward or reversible mechanism having variable speed designed as a part of the control system of the portable battery or electric drill, FIG. 4.
